(19) United States
(12) Patent Application Publication
(10) Pub. No.: US 2005/0255812 A1
(43) Pub. Date: Nov. 17, 2005

(54) RF front-end apparatus in a TDD wireless communication system

(75) Inventors: Kweon Na, Yongin-si (KR); Hyun-Su Yoon, Yongin-si (KR); Cheol-Woo Ahn, Suwon-si (KR); Jong-Hyun Lee, Suwon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/130,486

(22) Filed: May 17, 2005

(30) Foreign Application Priority Data
May 17, 2004 (KR) 2004-34599
Aug. 16, 2004 (KR) 2004-0064147

(51) Int. Cl. H04B 1/44

(52) U.S. Cl. 455/78; 455/83

(57) ABSTRACT

A transmitting apparatus in a TDD wireless communication system is provided. In the transmitting apparatus, a circulator transmits a signal received from a power amplifier to an antenna feed line and transmits a signal received from the antenna feed line to a quarter-wave transmission line. The quarter-wave transmission line is installed in a reception path, for reception isolation in a transmission mode. An RF switch shorts the load of the quarter-wave transmission line to the ground or connects the load of the quarter-wave transmission line to an LNA according to a control signal. The LNA low-noise-amplifies a signal received from the RF switch.

### PRIORITY

This application claims priority under 35 U.S.C. § 119 to applications entitled “RF Front-End Apparatus In A TDD Wireless Communication System” filed in the Korean Intellectual Property Office on May 17, 2004 and assigned Serial No. 2004-34599, and on Aug. 16, 2004 and assigned Serial No. 2004-64147, the contents of both of which are incorporated herein by reference.

### BACKGROUND OF THE INVENTION

1. Field of the Invention

The present invention relates generally to a radio frequency (RF) front-end apparatus in a time division duplex (TDD) wireless communication system, and in particular, to an apparatus for protecting a low-noise amplifier (LNA) in a reception part by attenuating transmission power introduced into the LNA.

2. Description of the Related Art

In a TDD wireless communication system, an RF front-end apparatus typically uses an RF switch or a circulator for TDD operation.

FIG. 1 illustrates the configuration of an RF front-end apparatus using an RF switch. Referring to FIG. 1, a power amplifier (PA) 102 is connected to the output port of a transmitter 101 and a receiver 103 is connected to the output port of an LNA 104. A single pole double through (SPDT) switch 105 switches a transmission signal received from the PA 102 to a filter 106 in a transmission mode. In reception mode, it switches a signal received from the filter 106 to the LNA 104. The filter 106 band-pass-filters the transmission signal and the received signal.

A directional coupler (D/C) 107 is connected between the filter 106 and an antenna, for coupling the transmission signal and the received signal. The coupled signals are used to monitor abnormalities in the transmission signal and the received signal. The RF front-end apparatus is configured so that the RF switch 105 switches between a transmission path and a reception path according to a control signal. This RF front-end configuration is usually adopted in a system that transmits at a power below 1 W.

FIG. 2 illustrates the configuration of an RF front-end apparatus using a circulator. Referring to FIG. 2, a PA 202 is connected to the output port of a transmitter 201 and a receiver 203 is connected to the output port of an LNA 204. A circulator 205 connects a transmission signal from the PA 202 to a filter 206 and connects a received signal from the filter 206 to the LNA 204. The filter 206 band-pass-filters the transmission signal and the received signal. Meanwhile, a D/C 207 is connected between the filter 206 and an antenna, for coupling the transmission signal and the received signal. The coupled signals are used to monitor abnormalities in the signals. The RF front-end apparatus separates transmission from reception, relying on the principle that the downlink experiences minimal signal attenuation and the uplink suffers great signal propagation loss. This RF front-end configuration finds its applications in systems that transmit at a power below several watts (e.g. 7 to 8 W).

While these RF front-end apparatuses with the configurations of FIGS. 1 and 2 can be applied to a TDD system using low-power RF signals, they are not viable in a system using high-power RF signals (at about 10 W or above) due to power rating, parts breakdown, and excessive cost in circuit implementation. In particular, implementation of an RF front-end to handle high power in the manner illustrated in FIG. 1 requires an unrealistically excessive cost. In addition, while the RF front-end apparatus illustrated in FIG. 2 is capable of processing up to medium power, problems with an antenna feed line may cause reflection of transmission power into the input port of the LNA, resulting in fatal damage to the input circuit of the LNA.

### SUMMARY OF THE INVENTION

An object of the present invention is to substantially solve at least the above problems and/or disadvantages and to provide at least the advantages below.

Accordingly, an object of the present invention is to provide an apparatus for processing a high-power RF signal in a TDD wireless communication system.

Another object of the present invention is to provide an apparatus for protecting the termination circuit of a PA and attenuating transmission power introduced into an LNA in a reception part in a transmission mode in a TDD wireless communication system.

To achieve the above objects, according to one aspect of the present invention, in a transmitting apparatus in a TDD wireless communication system, a circulator transmits a signal received from a power amplifier to an antenna feed line and transmits a signal received from the antenna feed line to a quarter-wave transmission line. The quarter-wave transmission line is installed in a reception path, for reception isolation in a transmission mode. An RF switch shorts the load of the quarter-wave transmission line to the ground, or, connects the load of the quarter-wave transmission line to an LNA according to a control signal. The LNA low-noise-amplifies a signal received from the RF switch.

According to another aspect of the present invention, in a transmitting apparatus in a TDD wireless communication system, a circulator transmits a signal received from a power amplifier to an antenna feed line and transmits a signal received from the antenna feed line to a predetermined transmission line. The transmission line is connected between the circulator and an RF switch. The RF switch connects the load of the transmission line to an open stub of a predetermined length or to an LNA according to a control signal. The LNA low-noise-amplifies a signal received from the RF switch.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates the configuration of an RF front-end apparatus using an RF switch;

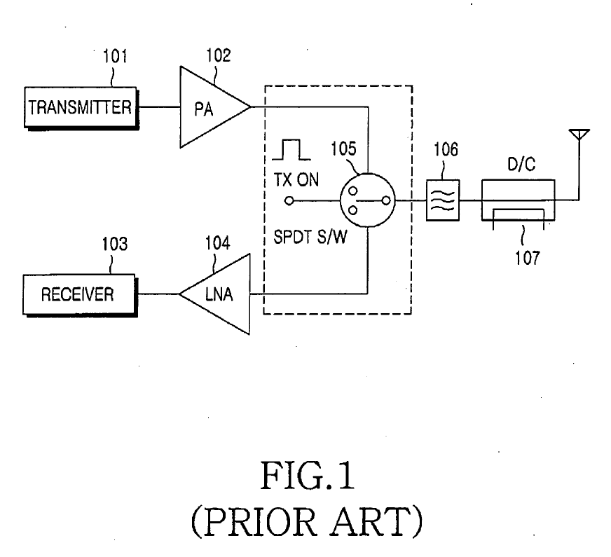

FIG. 2 illustrates the configuration of an RF front-end apparatus using a circulator;

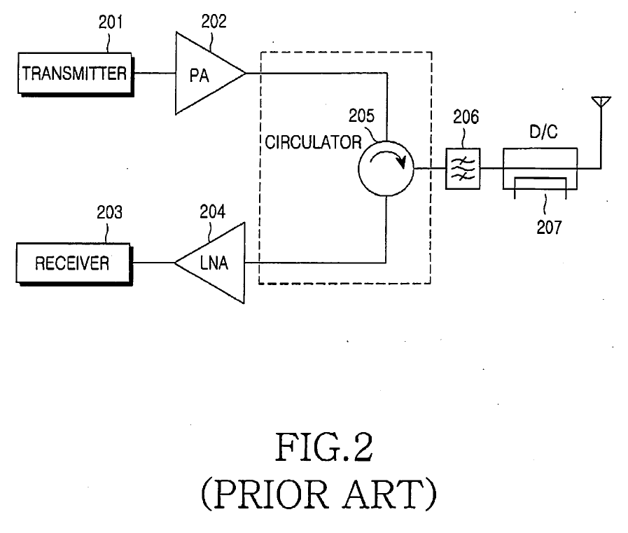

FIG. 3 illustrates the configuration of an RF front-end apparatus in a TDD system according to an embodiment of the present invention;

FIG. 4 is a diagrammatic representation of a normal transmission signal flow and circuit operation in the RF front-end apparatus of FIG. 3;

FIG. 5 is a diagrammatic representation of a transmission signal flow and circuit operation where an unexpected problem is encountered in the RF front-end apparatus of FIG. 3;

FIG. 6 is a diagrammatic representation of a received signal flow and a noise signal flow induced from a PA in the RF front-end apparatus of FIG. 3;

FIG. 7 illustrates the configuration of an RF front-end apparatus in a TDD system according to an alternative embodiment of the present invention;

FIG. 8 is a diagrammatic representation of a normal transmission signal flow and circuit operation in the RF front-end apparatus of FIG. 7;

FIG. 9 is a diagrammatic representation of a transmission signal flow and circuit operation in the case where an unexpected problem is encountered, such as a cut or short circuit in a transmission path in the RF front-end apparatus of FIG. 7; and

FIG. 10 is a diagrammatic representation of a received signal flow and a noise signal flow induced from a PA in the RF front-end apparatus of FIG. 7.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

The present invention is intended to provide an RF front-end apparatus for protecting the output port of a PA and the input port of an LNA in a high-power TDD wireless communication system.

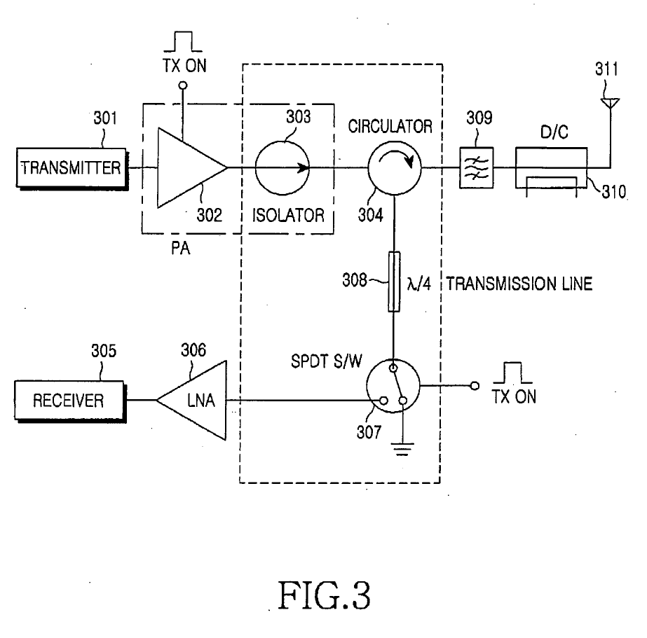

FIG. 3 illustrates an RF front-end apparatus in a TDD system according to an embodiment of the present invention.

Referring to FIG. 3, the RF front-end apparatus is comprised of a transmitter 301, a PA 302, an isolator 303, a circulator 304, a receiver 305, an LNA 306, an RF switch (SPDT switch) 307, a quarter-wave (λ/4) transmission line 308, a filter 309, a D/C 310, and an antenna 311. A quarter wave, λ/4, of the transmission line 308 is the length between the circulator 304 and the ground plane when the SPDT switch 307 is grounded. As known, waves have peak amplitudes at λ/4, 3λ/4, 5λ/4 . . . according to transmission line theory. Hence, the quarter-wave transmission line can be generalized as a

$$( \frac{λ}{4} + \frac{λ}{2} n , n = 0 , 1 , 2 , 3 , … )$$

transmission line.

In operation, the PA 302 amplifies the power of a transmission signal received from the transmitter 301. The isolator 303, connected to the output port of the PA 302, functions to protect the termination circuit of the PA 302. In addition, the isolator 303 terminates a reflected signal caused by an abnormality in an antenna feed line in a transmission mode. An isolator generally used at the output port of the PA 302 can be adopted as the isolator 303.

The circulator 304 provides an about 20-dB signal isolation between a transmission part including the PA 302 and the isolator 303 and a reception part including the quarter-wave transmission line 308 and the LNA 306. At the same time, the circulator 304 incurs a nearly 0.3-dB path loss between an antenna part including the filter 309 and the D/C 310 and the transmission/reception part. The circulator 304 transfers a signal received from the isolator 303 to the filter 309 or transfers a signal received from the filter 309 to the quarter-wave transmission line 308, according to its direction as illustrated in FIG. 3.

The filter 309, connected between the circulator 304 and the D/C 310, band-pass-filters the transmission signal and the received signal. The D/C 310 couples the transmission signal and the received signal between the filter 309 and the antenna 311. The coupled signals are used to monitor abnormalities in the transmission signal and the received signal.

The quarter-wave transmission line 308 is connected between the circulator 304 and ground. As stated earlier, the quarter-wave transmission line 308 covers a predetermined port of the circulator 304 to the ground plane when the SPDT switch 307 is grounded. The impedance seen from the circulator 304 is open (i.e. the SPDT switch 307 is grounded), or 50 Ω (i.e. the SPDT switch 307 is connected to the LNA 306) depending on the load state of the quarter-wave transmission line 308 (i.e. the connection state of the SPDT switch 307). If the SPDT switch 307 is grounded according to a control signal TX ON, the quarter-wave transmission line 308 provides an approximately 20-dB isolation between the circulator 304 and the SPDT switch 307.

The SPDT switch 307 shorts the load of the quarter-wave transmission line 308 to ground or connects it to the input port of the LNA 306 according to the control signal TX ON or TX OFF. Specifically, with the control signal TX ON, about 26-dB of isolation is provided between the quarter-wave transmission line 308 and the LNA 306. With the control signal TX OFF, a 0.3 to 0.4-dB signal loss occurs between the quarter-wave transmission line 308 and the input port of the LNA 306.

The SPDT switch 307 is provided as an example and can be replaced by a single-pole-single-through (SPST) switch. In this case, one port (Pole) of the SPST switch is connected to a predetermined port of the circulator 304 and the input port of the LNA 306 and the other port thereof (Through) is grounded. If the SPST switch is off, the load of the quarter-wave transmission line 308 is connected to the LNA 306. If the SPST switch is on, the load of the quarter-wave transmission line 308 is connected to ground. Thus, the quarter-wave transmission line 308 covers the predetermined port of the circulator 304 to ground by way of the SPST switch.

In a practical implementation, the SPDT switch and the SPST switch can be implemented using a PIN diode or a transistor (e.g. GaAs FET (Field Effect Transistor)). In the former case, a plurality of shunt PIN diodes are used to improve performance and the number of these shunt PIN diodes can be determined empirically by simulation or in another way. The shunt PIN diodes are preferably spaced at intervals of λ/4 between the circulator 304 and the LNA 306. It is assumed herein that the RF switch 307 is an SPDT switch.

The LNA 306 low-noise-amplifies a signal received from the SPDT switch 307 through the quarter-wave transmission line 308 and outputs the amplified signal to the receiver 305.

Now a description will be made of operations of the RF front-end apparatus having the configuration of FIG. 3.

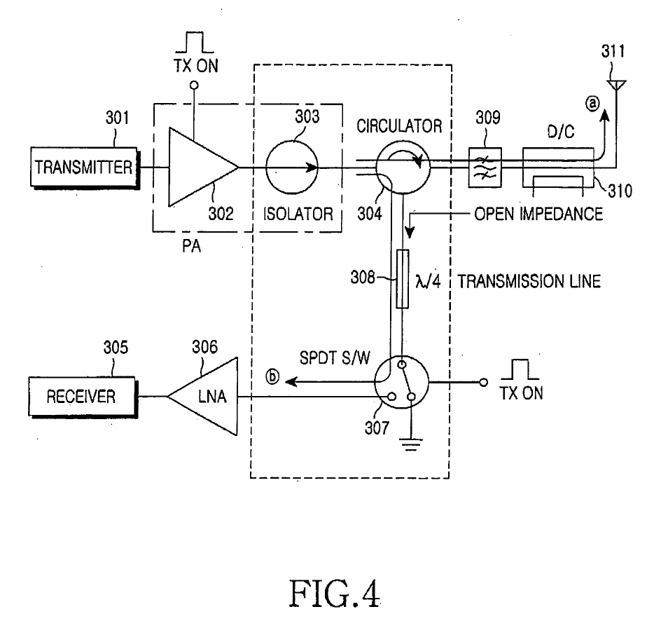

FIG. 4 is a diagrammatic representation of a normal transmission signal flow and circuit operation in the RF front-end apparatus illustrated in FIG. 3. It is important for transmission to prevent a high-power transmission signal from electrically damaging the input port of the LNA 306 in the reception part.

Referring to FIG. 4, a transmission signal of 60 W or so from the PA 302 is radiated in a path “a” running from the isolator 303 to the antenna 311 via the circulator 304, the filter 309 and the D/C 310 in this order. The SPDT switch 307 is kept grounded according to the control signal TX ON. Thus, the impedance seen from one end of the quarter-wave transmission line 308 having the other end shorted (e.g. a transmission line as long as one quarter of an effective wavelength at 2.35 GHz) is open according to the transmission line theory (∞=jZ₀ tan, βl, l=λ/4), thereby preventing introduction of the high-power transmission signal into the reception part. In this state, the quarter-wave transmission line 308 isolates the transmission signal by 20 dB or above. The SPDT switch 307 also isolates the transmission signal by approximately 26 dB when the UPG2009 chip manufactured by NEC is used.

Eventually, the transmission power induced along a path “b” due to leakage from the circulator 304 amounts to −18.5 dBm, resulting from calculating +47.8 dBm (PA output, 60 W)−0.3 dB (isolator loss)−20 dB (circulator isolation)−20 dB (λ/4 transmission line isolation)−26 dB (SPDT switch isolation).

The transmission power into the input port of the LNA 306, about −18 dBm is too small to inflict electrical damage on the input port of the LNA 306 in the reception part in the transmission mode, compared to Input IP3 (+12 dBm) at the input port of an LNA, for example, the MGA72543 LNA manufactured by Agilent.

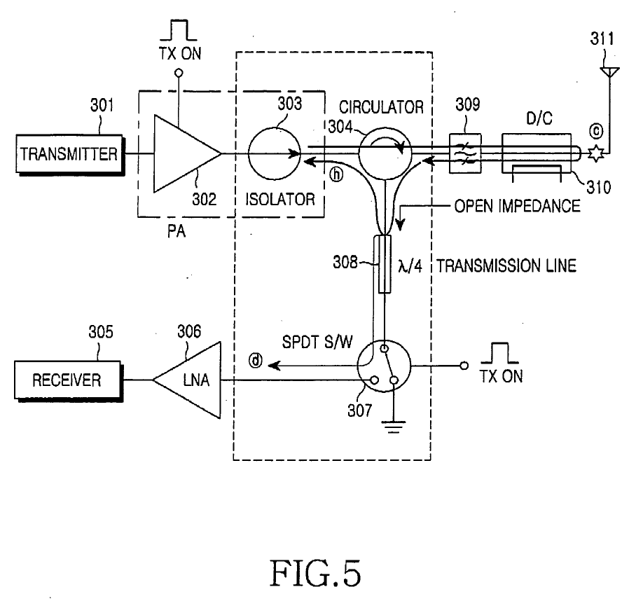

FIG. 5 is a diagrammatic representation of a transmission signal flow and circuit operation in the case where an unexpected problem is encountered, such as a cut or short circuit in a transmission path, in the RF front-end apparatus illustrated in FIG. 3. As described above with reference to FIG. 4, it is important for transmission to prevent a high-power transmission signal reflected at an antenna end “c” from inflicting electrical damage on the input port of the LNA 306 in the reception part. Compared to the transmission signal flow and circuit operation illustrated in FIG. 4, since the reflected power of the transmission signal is transferred along the reception path, the transmission-reception isolation that the circulator 304 otherwise might offer is not available. This implies that the input port of the receiving LNA 306 may suffer great adverse effects from the reflected transmission power.

Referring to FIG. 5, a transmission signal of 60 W or so output from the PA 302 is transferred to the isolator 303, the circulator 304, the filter 309, and the D/C 310 in that order. It is then reflected at the point “c” back to the D/C 310, the filter 309, and the circulator 304 sequentially. It is again reflected from the quarter-wave transmission line 308 in an open-circuit impedance state, transferred along a path “h”, and finally terminated at the isolator 303.

During the transmission signal flow, the SPDT switch 307 is kept grounded according to the control signal TX ON and the quarter-wave transmission line 308 presents an open-circuit impedance, as described before with reference to FIG. 4. Consequently, an 20-dB or above transmission signal isolation is provided between the circulator 304 and the SPDT switch 307. In this state, the power reflected from the transmission part along a path “d” into the input port of the LNA 306 in the reception part amounts to −1.5 dBm. Specifically, −1.5 dBm=+47.8 dBm (PA output, 60 W)−0.3 dB (isolator loss)−0.3 dB (circulator loss)−0.9 dB (filter insertion loss)−0.6 dB (D/C traveling loss)−0.9 dB (filter insertion loss)−0.3 dB (circulator loss)−20 dB (quarter-wave transmission line isolation)−26 dB (SPDT switch isolation).

The power reflected from the transmission part into the input port of the LNA 306, about −1.5 dBm is 13.5 dB smaller than Input IP3 (+12 dBm) at the input port of the LNA, MGA72543 of Agilent in FIG. 5. Exceeding the expectation that the absence of electrical isolation between transmission and reception, that the circulator 304 otherwise might provide, may destroy the input port of the LNA 306, the high-power transmission signal still inflicts no electrical damage on the input port of the LNA 306. In addition, the configuration of this RF front-end apparatus offers the benefit of protecting the output port of the PA 302 because the reflected transmission power is terminated at the isolator 303.

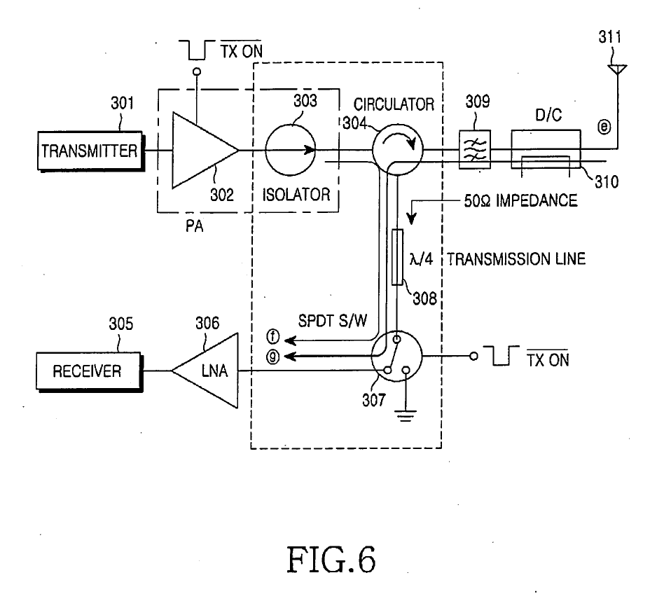

FIG. 6 is a diagrammatic representation of a received signal flow and a noise signal flow induced from a PA in the RF front-end apparatus of FIG. 3. It is important to signal reception to reduce noise power from the PA 302 and signal loss at the antenna 311 having a direct effect on noise figure (NF) and the input port of the LNA 306.

Referring to FIG. 6, the port of the SPDT switch 307 shorted to the ground is switched to the input port of the LNA 306 according to the control signal TX OFF. The impedance seen from the other end of the quarter-wave transmission line 308 is 50 Ω (short impedance) according to the transmission line theory (50 Ω=Zₒ²/ZL, ZL=50), causing almost no reception loss on the quarter-wave transmission line 308. The signal loss between the antenna 311 and the input port of the LNA 306 along a path “g” amounts to −1.9 dB. Specifically, −1.9 dBm=−0.3 dB (D/C loss)−0.9 dB (filter insertion loss)−0.3 dB (circulator loss)−0.4 dB (SPDT switch loss).

The signal loss between the antenna 311 and the input port of the LNA 306, about −1.9 dB is a typical value common to other systems as well as this RF front-end apparatus. Accordingly, the present invention suffers no Noise Figure (NF) degradation.

Meanwhile, a bias control signal (e.g., a gate bias control signal) is turned off for the PA 302 to minimize the effects of the PA 302 on the impedance of the reception part. At the same time, the circulator 304 provides 20-dB of isolation from the output noise of the PA 302. The power induced from the PA 302 for which the bias control signal is off into the input port of the LNA 306 along a path “f” amounts to −104.7 dBm/10 MHz. Specifically, −104.7 dBm/10 MHz=−84 dBm/10 MHz (PA power)−0.3 dB (isolator loss)−20 dB (circulator isolation)−0.4 (SPDT switch loss).

The power induced from the PA 302 into the input port of the LNA 306, about −104.7 dBm/10 MHz, is almost the same level as thermal noise, having no influence on reception performance. That is, the RF front-end apparatus illustrated in FIG. 3 is configured to receive signals in an optimum state.

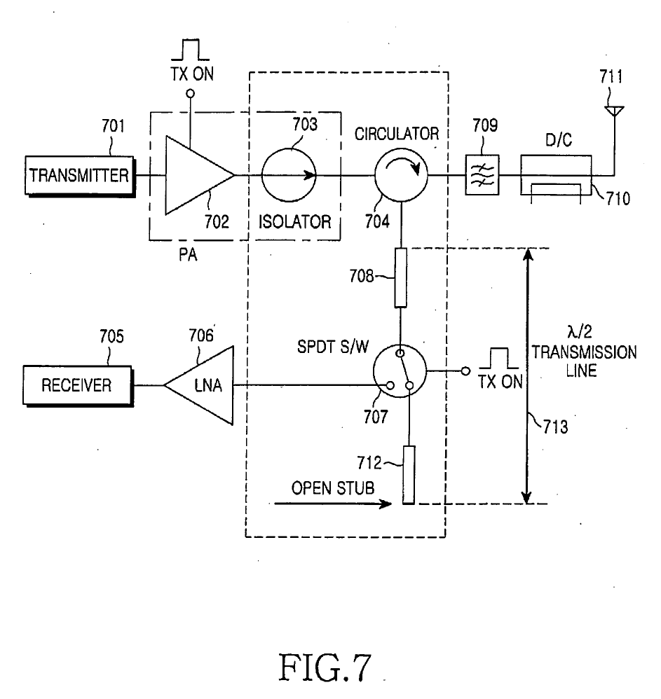

FIG. 7 illustrates the configuration of an RF front-end apparatus in a TDD system according to an alternative embodiment of the present invention. This RF front-end apparatus differs from that illustrated in FIG. 3 in that a transmission line is connected between a circulator and an SPDT switch and a predetermined port of the SPDT switch is connected to an open stub of a predetermined length rather than ground, so that a transmission line used for reception isolation in the transmission mode is eventually as long as λ/2. The total length of the transmission line, the switch and the open stub is λ/2 with the switch at the center of the length λ/2. From this perspective, the transmission line, the switch and the open stub collectively form a λ/2 transmission line. As known, since waves have peak amplitudes at λ/2, λ, 3λ/2 . . . according to the transmission line theory, the λ/2 transmission line can be generalized as a

$$( \frac{λ}{2} + \frac{λ}{2} n , n = 0 , 1 , 2 , 3 , … )$$

transmission line.

Referring to FIG. 7, the RF front-end apparatus includes a transmitter 701, a PA 702, an isolator 703, a circulator 704, a receiver 705, an LNA 706, an RF switch (SPDT switch) 707, a transmission line 708, a filter 709, a D/C 710, an antenna 711, and an open stub 712. The RF switch 707 is an SPDT one or an SPST one, as stated earlier. These RF switches can be implemented using a PIN diode, a transistor (e.g., GaAs FET transistors), etc. The following description is made of other major components of the RF front-end apparatus, apart from the afore-described components.

Referring to FIG. 7, the circulator 704 provides nearly 20-dB signal isolation between a transmission part including the PA 702 and the isolator 703 and a reception part including the λ/2 transmission line 713 and the LNA 706. At the same time, the circulator 704 causes about a 0.3-dB path loss between an antenna part including the filter 709 and the D/C 710 and the transmission/reception part.

Depending on its load state (i.e., the connection state of the SPDT switch 707), the impedance of the λ/2 transmission line 713 seen from the circulator 704 is open (i.e., the SPDT switch 707 is connected to the open stub 712) or 50 Ω (i.e., the SPDT switch 707 is connected to the LNA 706). When the SPDT switch 707 is connected to the open stub 712 according to the control signal TX ON, approximately 20-dB signal isolation is provided between the circulator 704 and the SPDT switch 707.

The SPDT switch 707 switches the transmission line 708 to the open stub 712 or the input port of the LNA 706 according to the control signal TX ON or TX OFF. In the transmission mode (i.e., TX ON), an about 26-dB signal isolation is provided between the transmission line 708 and the LNA 706, while in the reception mode (i.e., TX OFF), an about 0.3 to 0.4-dB insertion loss occurs between them. Specifically, when the SPDT switch 707 switches to the open stub 712, peak amplitude is observed at a point λ/4 spaced from a point shorted by the SPDT switch 707 (a zero-amplitude point), thereby rendering the impedance of the λ/2 transmission line 713 open.

The isolator 703 terminates a transmission signal reflected back due to an abnormality in an antenna feed line in the transmission mode and protects the termination circuit of the PA 702 as well.

The operation of the RF front-end apparatus having the configuration illustrated in FIG. 7 will now be described.

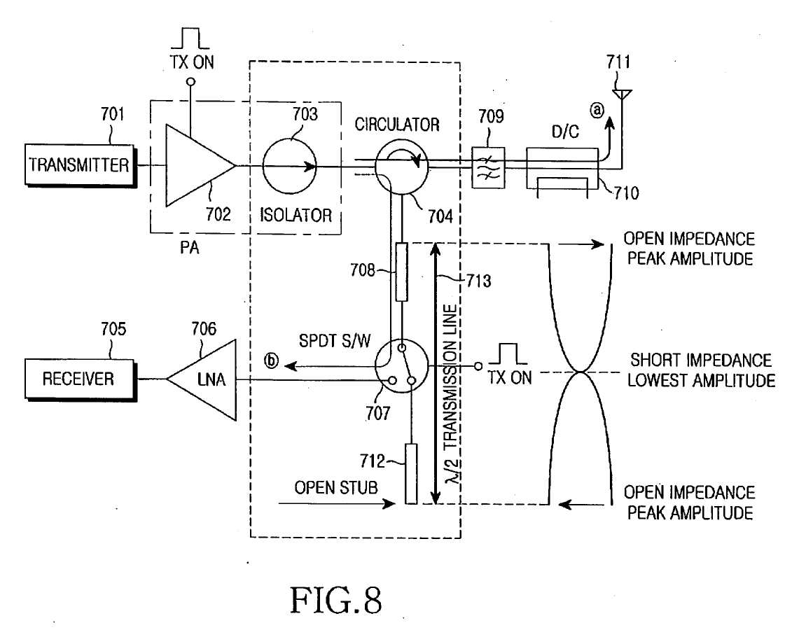

FIG. 8 is a diagrammatic representation of a normal transmission signal flow and circuit operation in the RF front-end apparatus of FIG. 7. It is very important for transmission that no electrical damage is inflicted on the input port of the LNA 706 in the reception part.

Referring to FIG. 8, a transmission signal of 60 W or so output from the PA 702 is radiated in a path “a” running from the isolator 703 to the antenna 711 through the circulator 704, the filter 709 and the D/C 710 in that order. A port of the SPDT switch 707 is connected to the open stub 712 according to the control signal TX ON. Thus, the impedance seen from one end of the λ/2 transmission line 713 having the other end shorted (e.g., a transmission line as long as one half of an effective wavelength at 2.35 GHz) is open according to the transmission line theory (∞=jZ₀ cot βl, β=2π/λ, l=λ/2), thereby preventing introduction of the high-power transmission signal into the reception part.

Meanwhile, the transmission power induced along a path “b” induced into the input port of the LNA 706 in the reception part due to leakage from the circulator 704 amounts to −18.5 dBm. This value is too small to inflict electrical damage on the input port of the LNA 706 in the transmission mode, compared to Input IP3 (+12 dBm) at the input port of the LNA, 706.

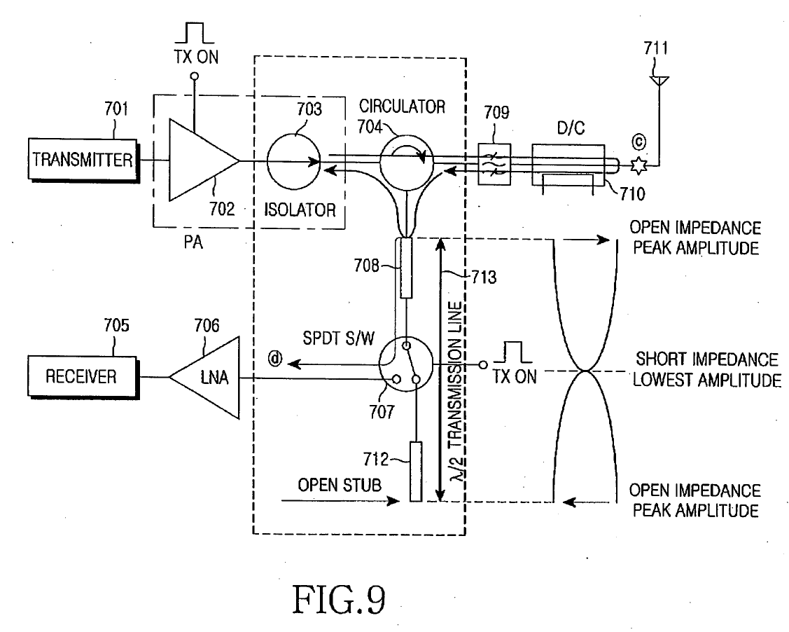

FIG. 9 is a diagrammatic representation of a transmission signal flow and circuit operation where an unexpected problem is encountered, such as a cut or short circuit in a transmission path in the RF front-end apparatus of FIG. 7.

As stated before, it is very important to prevent a high-power transmission signal, reflected from an antenna end “c”, from inflicting electrical damage on the input port of the LNA 706 in the reception part. Compared to the transmission signal flow and circuit operation illustrated in FIG. 8, since the reflected power of the transmission signal is transferred along the reception path, the transmission-reception isolation that the circulator 704 otherwise might offer is not available. Therefore, the input port of the LNA 706 may suffer great adverse effects from the reflected transmission power.

Referring to FIG. 9, a transmission signal of 60 W or so output from the PA 702 is transferred to the isolator 703, the circulator 704, the filter 709, and the D/C 710 in that order. It is then reflected at the point “c” back to the D/C 710, the filter 709, and the circulator 704 sequentially. It is again reflected from the λ/2 transmission line 713 in an open-circuit impedance state, transferred and finally terminated at the isolator 703.

During the transmission signal flow, the SPDT switch 707 renders the load of the λ/2 transmission line 708 to be open according to the control signal TX ON. Consequently, 20-dB or above transmission signal isolation is provided between the circulator 704 and the SPDT switch 707. In this state, the power reflected from the transmission part along a path “d” into the input port of the LNA 706 in the reception part amounts to −1.5 dBm. This value is 13.5 dB smaller than Input IP3 (+12 dBm) at the input port of the LNA.

As described above, exceeding the expectation that the absence of the electrical isolation between transmission and reception that the circulator 704 otherwise might provide may destroy the input port of the LNA 706, the high-power transmission signal still inflicts no electrical damage on the input port of the LNA 706. Another benefit of the configuration of this RF front-end apparatus is to protect the output port of the RA 702 because the reflected transmission power is terminated at the isolator 703.

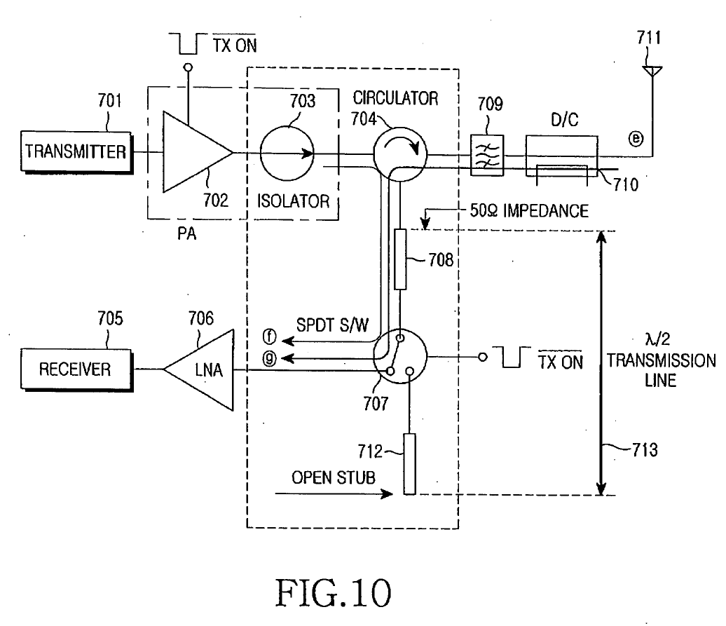

FIG. 10 is a diagrammatic representation of a received signal flow and a noise signal flow induced from a PA in the RF front-end apparatus illustrated in FIG. 7. It is important for reception to reduce noise power induced from the PA 702 and signal loss at the antenna 711 having a direct effect on NF and the input port of the LNA 706.

Referring to FIG. 10, the end of the SPDT switch 707, connected to the open stub 712, is switched to the input port of the LNA 706 according to the control signal TX OFF. The impedance seen from the other end of the λ/2 transmission line 713 is 50 Ω (short impedance) according to the transmission line theory (50 Ω=Zₒ²/ZL, ZL=50). Therefore, reception loss is scarcely present on the λ/2 transmission line 713. The signal loss between the antenna 711 and the input port of the LNA 706 along a path “g” amounts to −1.9 dB. This is a typical value common to other systems as well as this RF front-end apparatus. Accordingly, the present invention suffers no NF degradation.

Meanwhile, a bias control signal (e.g., a gate bias control signal) is turned off for the PA 702 to minimize the effects of the PA 702 on the impedance of the reception part. At the same time, the circulator 704 provides about 20-dB isolation from the output noise of the PA 702. The power induced from the PA 702 for which the bias control signal is off into the input port of the LNA 706 along a path “f” amounts to −104.7 dBm/10 MHz, as in the one embodiment of the present invention. This is almost the same level as thermal noise, having no influence on reception performance. That is, the RF front-end apparatus illustrated in FIG. 7 is configured as to receive signals in an optimal reception mode.

It should be noted that it is preferred that the first embodiment of the present invention discussed above is applied to a system using a frequency ranging from 2 to 3 GHz and the alternative embodiment of the present invention is applied to a system using a frequency higher than 3 GHz. The reason is that a λ/4 transmission line becomes short at above 3 GHz. For example, for a printed circuit board (PCB) having a dielectric constant of 4.7 at a frequency of 4 GHz, one quarter of an effective wavelength is about 8.6 mm and an SPDT switch and its peripheral circuit alone exceeds this length. Therefore, for frequencies higher than 3 GHz, the circuit is designed so that a transmission line for reception isolation is λ/2 in length, as in the alternative embodiment of the present invention.

As described above, the present invention is advantageous in that the output port of a PA is protected and an LNA is protected by attenuating transmission power introduced into the LNA in a transmission mode in a high-power TDD wireless communication system. Especially, application of the inventive RF front-end configurations to the RF front end of high speed portable Internet (HPI) system under active development can solve technical problems involved in the TDD operation of a high-power signal. Meanwhile, since a circulator, an isolator, a transmission line and an SPDT switch can be integrated in a single module according to an embodiment of the present invention, technology transfer with accompanying revenue generation will expectedly be facilitated.

While the invention has been shown and described with reference to certain preferred embodiments thereof, it will be understood by those skilled in the art that various changes in form and details may be made therein without departing from the spirit and scope of the invention as defined by the appended claims.

1. A transmitting apparatus in a time division duplex (TDD) wireless communication system, comprising:
a circulator for transmitting a signal received from a power amplifier to an antenna feed line and transmitting a signal received from the antenna feed line to a quarter-wave transmission line;
the quarter-wave transmission line installed in a reception path, for reception isolation in a transmission mode; and
a radio frequency (RF) switch for shorting a load of the quarter-wave transmission line to ground or connecting the load of the quarter-wave transmission line to a low-noise amplifier (LNA) according to a control signal;
the LNA for low-noise-amplifying a signal received from the RF switch.

2. The transmitting apparatus of claim 1, further comprising an isolator for protecting an output port of the power amplifier and terminating a signal reflected back from the antenna feed line.

3. The transmitting apparatus of claim 1, wherein an impedance of the quarter-wave transmission line seen from the circulator becomes an open-circuit or short-circuit impedance according to a connection state of the RF switch.

4. The transmitting apparatus of claim 1, wherein the RF switch is a single pole double through (SPDT) switch or a single pole single through (SPST) switch.

5. The transmitting apparatus of claim 1, wherein the RF switch is implemented using a PIN diode or a transistor.

6. The transmitting apparatus of claim 1, wherein a length of the quarter-wave transmission line between the circulator and the ground is
$$( \frac{λ}{4} + \frac{λ}{2} n , n = 0 , 1 , 2 , 3 , … ) .$$

7. The transmitting apparatus of claim 1, wherein the power amplifier is biased off in a reception mode.

8. A transmitting apparatus in a time division duplex (TDD) wireless communication system, comprising:
a circulator for transmitting a signal received from a power amplifier to an antenna feed line and transmitting a signal received from the antenna feed line to a predetermined transmission line;
the transmission line connected between the circulator and a radio frequency (RF) switch; and
the RF switch for connecting a load of the transmission line to an open stub of a predetermined length or to a low-noise amplifier (LNA) according to a control signal;
the LNA for low-noise-amplifying a signal received from the RF switch.

9. The transmitting apparatus of claim 8, wherein the transmission line, the RF switch, and the open stub are connected and form a transmission line having a length of
$$( \frac{λ}{2} + \frac{λ}{2} n , n = 0 , 1 , 2 , 3 , … ) .$$

10. The transmitting apparatus of claim 8, further comprising an isolator for protecting an output port of the power amplifier and terminating a signal reflected back from the antenna feed line.

11. The transmitting apparatus of claim 8, wherein an impedance of the transmission line seen from the circulator becomes an open-circuit or short-circuit impedance according to a connection state of the RF switch.

12. The transmitting apparatus of claim 8, wherein the RF switch is a single pole double through (SPDT) switch or a single pole single through (SPST) switch.

13. The transmitting apparatus of claim 8, wherein the RF switch is implemented using a PIN diode or a transistor.

14. The transmitting apparatus of claim 8, wherein the power amplifier is biased off in a reception mode.

15. A transmitting apparatus in a time division duplex (TDD) wireless communication system, comprising:
a circulator for transmitting a signal received from a power amplifier to an antenna feed line and transmitting a signal received from the antenna feed line to a predetermined transmission line; and
the transmission line being a predetermined length installed in a reception path, a load impedance of the transmission line being an open-circuit impedance in a transmission mode.

16. The transmitting apparatus of claim 15, wherein a length of the transmission line is
$$( \frac{λ}{4} + \frac{λ}{2} n , n = 0 , 1 , 2 , 3 , … ) .$$

17. The transmitting apparatus of claim 15, wherein a length of the transmission line is
$$( \frac{λ}{2} + \frac{λ}{2} n , n = 0 , 1 , 2 , 3 , … ) .$$

18. The transmitting apparatus of claim 15, further comprising a radio frequency (RF) switch installed at a predetermined position of the transmission line, for switching a load of the transmission line to a low-noise amplifier (LNA) in a reception mode.

19. The transmitting apparatus of claim 18, wherein the RF switch is a single pole double through (SPDT) switch or a single pole single through (SPST) switch.

20. The transmitting apparatus of claim 18, wherein the RF switch is implemented using a PIN diode or a transistor.

21. The transmitting apparatus of claim 15, wherein one end of the transmission line is connected to the circulator and another end of the transmission line is grounded or formed as an open stub.

22. The transmitting apparatus of claim 15, wherein the power amplifier is biased off in the reception mode.

23. The transmitting apparatus of claim 15, further comprising an isolator for protecting an output port of the power amplifier and terminating a signal reflected back from the antenna feed line.
